(19) United States
(12) Patent Application Publication
(10) Pub. No.: US 2005/0052997 A1
(43) Pub. Date: Mar. 10, 2005

(54) Packet scheduling of real time packet data

(76) Inventor: Hector Montes Linares, Granada (ES)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/961,484

(22) Filed: Oct. 12, 2004

Related U.S. Application Data
(63) Continuation of application No. PCT/FI03/00213, filed on Mar. 19, 2003.

(30) Foreign Application Priority Data
Apr. 9, 2002 (FI) 20020673

(51) Int. Cl. H04L 1/00

(52) U.S. Cl. 370/230; 370/235; 370/401

(57) ABSTRACT

The present invention concerns packet scheduling for a packet data enabled radio communication network. A packet data traffic flow is classified into service class specific traffic queues. The traffic flow comprising one or more data connections of predetermined service classes, at least one of the service classes being real time streaming traffic with a predetermined guaranteed bit rate requirement. A real time streaming service class specific traffic queue is metered to determine whether its bit rate is below or over its guaranteed bit rate requirement, based on which at least one first scheduling weight for the metered real time streaming service class specific traffic queue is determined. At least one second scheduling weight for at least one remaining traffic queue is determined. The traffic queues are scheduled according to the determined scheduling weights.

This is a Continuation of International Application No. PCT/FI03/00213 filed Mar. 19, 2003, which designated the U.S. and was published under PCT Article 21(2) in English.

### FIELD OF THE INVENTION

The present invention relates to telecommunications. In particular, the present invention relates to a novel and improved packet scheduling method, system and apparatus for a packet data enabled radio communication network.

### BACKGROUND OF THE INVENTION

Recently radio communication systems such as mobile communication networks have started to provide packet data services for the users in addition to traditional circuit switched services. A circuit switched service is a type of service for which a physical path is dedicated to a single connection between two endpoints in the network for the duration of the connection. For example ordinary voice phone service is circuit-switched. Packet switched data service, on the other hand, describes a type of service in which relatively small units of data called packets are routed through a network based on the destination address contained within each packet. In the following the terms packet switched and packet are used interchangeably unless otherwise noted. Breaking communication down into packets allows the same data path to be shared among many users in the network. This type of communication between sender and receiver is commonly referred to as connectionless rather than dedicated. Most traffic over the Internet uses packet switching and the Internet is basically a connectionless network.

Packet data services provide several advantages over circuit switched data services traditionally used in mobile networks. They provide significantly higher maximum transmission speeds. They facilitate instant connections whereby information can be sent or received immediately as the need arises, subject to radio coverage. No dial-up modem connection, for example, is necessary.

In a typical packet data enabled radio communication network a mobile station can send and receive packet data related to several different data connections simultaneously. A packet data traffic flow refers to the packet data corresponding to one or more simultaneous data connections. In the following the terms packet data traffic flow and traffic flow are used interchangeably unless otherwise noted. For example, packet data corresponding to an email message comprises a data connection. Packet data corresponding to a World Wide Web (WWW) browsing session comprises another data connection. When transmitted simultaneously to or from a given mobile station, these two data connections comprise a traffic flow. Thus a packet data enabled mobile station can typically send and receive a packet data traffic flow comprising several simultaneous data connections.

Data services may be categorized into real time (RT) and non-real time (nRT) services. Non-real time services may comprise for example sending and receiving emails, and interactive browsing of the World Wide Web. Real time services may comprise for example streaming services such as multimedia transmissions. Traditionally real time services have mostly been implemented as circuit switched services but recently also real time packet data services have started to emerge.

Quality of Service (QoS) is a concept used to provide differentiated data services. The data services are categorized into various service classes based on given predefined parameters, e.g. bandwidth, bit rate and or delay. A typical example of a service class is background services. Data services of this service class are typically provided network resources on a best-effort basis. Another typical example of a service class is interactive services. Data services of this service class do not typically require real time connections. Yet another example of a service class is real time streaming services. Data services of this service class do typically require real time connections. Typically for a service associated with a service class providing real time connections a guaranteed bit rate requirement is negotiated beforehand, after which a connection of at least the guaranteed bit rate is to be provided.

An example of packet data service for digital mobile communication networks is General Packet Radio Service (GPRS). GPRS is designed to support especially digital mobile networks based on the GSM (Global System for Mobile Communications) standard. However, GPRS is not restricted to only GSM networks but may support for example digital mobile networks based on the IS-136 Time Division Multiple Access (TDMA) standard. Additionally, GPRS may also act as an access network for an IP Multimedia Subsystem (IMS).

A GPRS enabled mobile communication network comprises two additional network elements or nodes. These are a Serving GPRS Support Node (SGSN) and a Gateway GPRS Support Node (GGSN). An SGSN typically delivers packets to GPRS enabled mobile stations (MS) within its service area. It may further send queries to a Home Location Register (HLR) to obtain profile data of GPRS subscribers. It may further detect new GPRS enabled mobile stations in a given service area, process registration of new mobile subscribers, and keep a record of their location inside a given area. A GGSN is typically used as an interface to external IP networks such as the Internet, other mobile service providers' GPRS services, or enterprise intranets. A GGSN may maintain routing information necessary to tunnel the protocol data units (PDU) to the SGSN that services a particular MS. An SGSN connects to the Base Station Subsystem (BSS) or base station of the mobile communication network through an interface referred to as Gb interface.

An important function to be performed by a packet data service such as GPRS is flow control. The GPRS standards (ETSI TS 101 343 and 3GPP TS 08.18) define a flow control mechanism through the Gb interface to control the traffic flows between an SGSN and a BSS. The mechanism is both network cell and MS specific. The mechanism is implemented in BSS GPRS Protocol (BSSGP), which is a protocol used in GPRS e.g. for processing routing and Quality of Service information for a BSS, thus it is often referred to as BSS GPRS Protocol Flow Control or BSSGP Flow Control. Thus BSSGP Flow Control limits the amount of traffic a user can send through the Gb interface. The BSSGP Flow Control is usually performed by an SGSN.

The following is a more detailed review of the BSSGP Flow Control as it is implemented in prior art. FIG. 1 illustrates how an SGSN performs flow control on each BSSGP Virtual Connection (BVC) and each mobile station MS1, MS2 and MS3. The flow control in the SGSN is performed on Logical Link Control Packet Data Units (LLC-PDU). The LLC is a data link layer protocol used in GPRS e.g. for assuring the reliable transfer of user data across a wireless network. The flow control is performed on each LLC-PDU first by the MS specific flow control mechanism, and then by the BVC specific flow control mechanism. If the LLC-PDU is passed by the individual MS specific flow control, the SGSN then applies the BVC specific flow control to the LLC-PDU. If the LLC-PDU is passed by both flow control mechanisms, the entire LLC-PDU is delivered forward to be transmitted to the BSS.

FIG. 2 illustrates a BSSGP Flow Conformance Definition Algorithm used to decide which LLC-PDUs are conforming to the flow to an MS or in a BVC over the Gb interface. An SGSN is to transmit no more data than that which can be accommodated within a BSS buffer for a BVC or individual MS. A BSS sends a corresponding SGSN flow control parameters allowing the SGSN to control locally its transmission output in the SGSN to BSS-direction. These parameters comprise the following:

Bₘₐₓ: bucket size for a given BVC or MS in the downlink direction (i.e. from SGSN to BSS). It is set by a corresponding BSS for each cell and each mobile station. It is large enough to accommodate at least one LLC-PDU; and

R: bucket leak rate for a given BVC or MS in the downlink direction.

The SGSN performs flow control on an individual MS using SGSN determined values of Bₘₐₓ and R unless it receives a FLOW-CONTROL-MS-message from the BSS regarding that BSS. The BSS may update the values of Bₘₐₓ and R within the SGSN at any time by transmitting a new Flow Control PDU containing the new values for Bₘₐₓ and R.

The rest of the variables used by the algorithm are:
B: bucket counter;
B*: predicted value of the bucket counter;
L(p): length of LLC-PDU p;
Tp: the time that the last LLC-PDU p was transferred; and
Tc: arrival time of LLC-PDU p.

As illustrated in FIG. 2, first the predicted value for the bucket is calculated by adding the size of the incoming packet and subtracting the predicted value of the outgoing packets (Tc−Tp)×R. Next, it is checked whether the predicted value of the bucket is smaller than the size of the incoming packet or not, which situation may happen when the prediction (Tc−Tp)×R is greater than the value of the bucket counter B. Finally, it is checked whether the maximum value for the bucket counter, i.e. the bucket size Bₘₐₓ, has been exceeded or not. If it has been exceeded, the packet is delayed due to flow control decision. If it has not been exceeded, the LLC-PDU is sent. The algorithm illustrated in FIG. 2 is also referred to as token bucket-based in the prior art.

However, this prior art flow control has some considerable shortcomings. Some users may send simultaneously RT data connections requiring a guaranteed QoS in terms of bit rate, e.g. multimedia streaming services, and nRT data connections requiring only qualitative QoS, i.e. relative priorities among various data connections but no absolute values of bit rate or delay. Assuming a BSS guarantees QoS in terms of throughput, in the particular case in which a user has at least a RT data connection and an nRT one, the nRT data connection may block the RT one through the Gb interface. Thus it follows that the negotiated QoS requirement as a guaranteed bit rate cannot be fulfilled, thereby making the Gb interface a bottleneck for the system.

Thus there is need for a solution improving the user satisfaction ratio for streaming users by making it possible to prevent the non-real time data connections of a user from having an effect on the real time data connections of the same user.

### SUMMARY OF THE INVENTION

The present invention concerns a packet scheduling method, system and apparatus for a packet data enabled radio communication network. The system comprises a base station for transmitting a packet data traffic flow comprising one or more data connections of predetermined service classes. Thus the traffic flow may comprise several data connections each of a different service class. The traffic flow may also comprise several data connections some of which belong to a same service class. At least one of the service classes is real time streaming traffic with a predetermined guaranteed bit rate requirement. Thus there may also be more than one real time streaming traffic service classes, each with its own predetermined guaranteed bit rate requirement. The system further comprises a terminal device for receiving the transmitted traffic flow. The system further comprises a classifier for classifying the traffic flow to be transmitted into service class specific traffic queues. Thus data connections belonging to a common service class but otherwise unrelated are classified into a same traffic queue.

According to the invention the system comprises a first weight calculator for determining at least one first scheduling weight for a real time streaming service class specific traffic queue. Further according to the invention the system comprises a second weight calculator for determining at least one second scheduling weight for at least one remaining traffic queue. Further according to the invention the system comprises a scheduler for scheduling the traffic queues according to the determined scheduling weights. Preferably the scheduler is implemented by utilizing a Weighted Round Robin-algorithm. Weighted Round Robin-scheduling comprises allocating the available bandwidth among the various queues so that each queue is allocated a percentage of the total bandwidth proportional to its scheduling weight. Weighted Round Robin-scheduling in itself is well known in the prior art, thus it is not disclosed in further detail here.

In an embodiment of the invention the system further comprises a meter for metering a real time streaming service class specific traffic queue to determine whether its bit rate is below or over its guaranteed bit rate requirement. Preferably the meter is implemented by utilizing a first token bucket-algorithm having a first bucket size B_{streaming}. Preferably the first weight calculator determines the first scheduling weight or weights for the real time streaming service class specific traffic queue based on whether its determined bit rate is below or over its guaranteed bit rate requirement.

In an embodiment of the invention the system further comprises a policer for policing the traffic flow before classifying in order to conform the flow to a predetermined maximum bit rate. Again, policing as well as shaping a traffic flow in themselves are well known in the prior art, thus are not disclosed in further detail here.

In an embodiment of the invention the system further comprises a flow controller for applying flow control to the scheduled traffic flow. Preferably the flow controller is implemented by utilizing a second token bucket-algorithm having a second bucket size Bₘₐₓ.

In an embodiment of the invention the scheduler and flow controller are co-ordinated with each other by determining the scheduling weights as:

first weight for a real time streaming service class specific traffic queue: B_{streaming}/Bₘₐₓ, and

second weight for a remaining traffic queue i: wₒᵢ×(1−B_{streaming}/Bₘₐₓ) ,

where wₒᵢ is the relative priority for a data connection i, so that Σwₒᵢ=1. The result of this is that, e.g. when the flow controller decreases the second bucket size Bₘₐₓ until Bₘₐₓ=2×B_{streaming}, half of the traffic going to a given base station will consist of the guaranteed streaming traffic, i.e. the traffic the token bucket rate has marked as guaranteed based on the guaranteed bit rate requirement.

In an embodiment of the invention the packet data enabled radio communication network is a GPRS enabled radio communication network. Preferably the classifier, meter, first weight calculator, second weight calculator, scheduler, policer and flow controller are implemented in an SGSN-element of the GPRS enabled radio communication network.

In an embodiment of the invention the radio communication network is a GSM network.

The invention makes it possible to prevent the non real time data connections of a user from having an effect on the real time data connections of the same user. Several data connections of the same user sharing a bit pipe through the Gb interface are managed by the present invention, of which data connections each may have a different QoS requirement. By using terminal equipment specific BSSGP Flow Control information and guaranteed bit rate requirement, a packet scheduler according to the present invention allows for guaranteeing a negotiated QoS.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates flow control according to prior art,

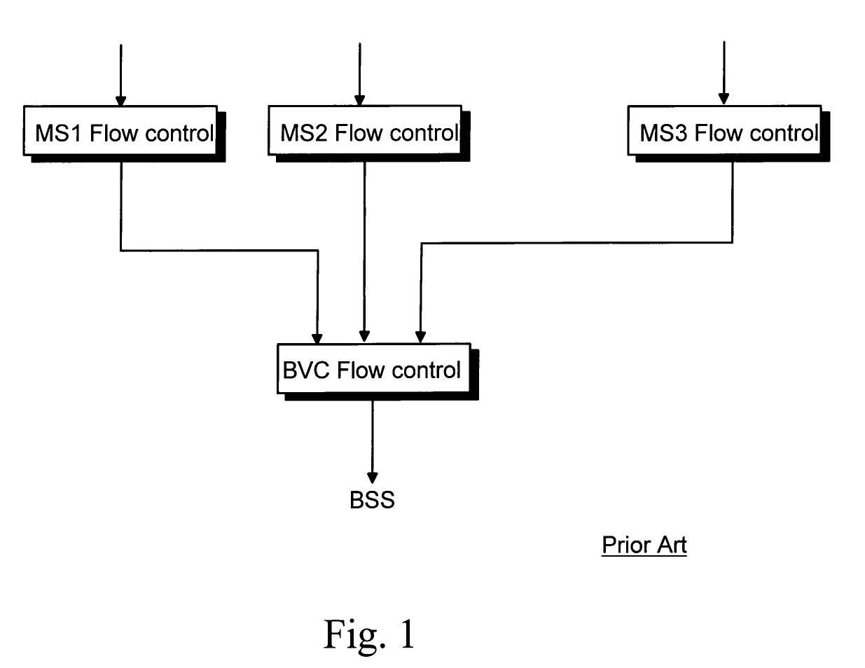

FIG. 2 illustrates a flow control algorithm according to prior art,

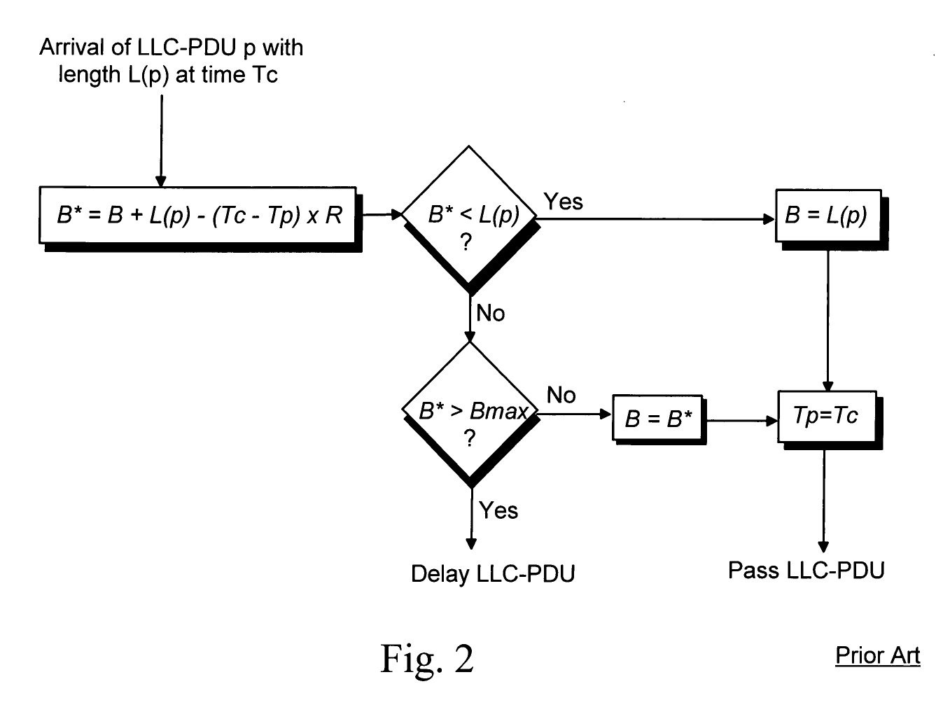

FIG. 3 is a flow chart illustrating a method according to one embodiment of the present invention,

FIG. 4 is a block diagram illustrating a system according to one embodiment of the present invention,

FIG. 5 further illustrates a scheduler according to one embodiment of the present invention, and

FIG. 6 further illustrates the benefits of the present invention.

### DETAILED DESCRIPTION OF THE INVENTION

Reference will now be made in detail to the embodiments of the present invention, examples of which are illustrated in the accompanying drawings.

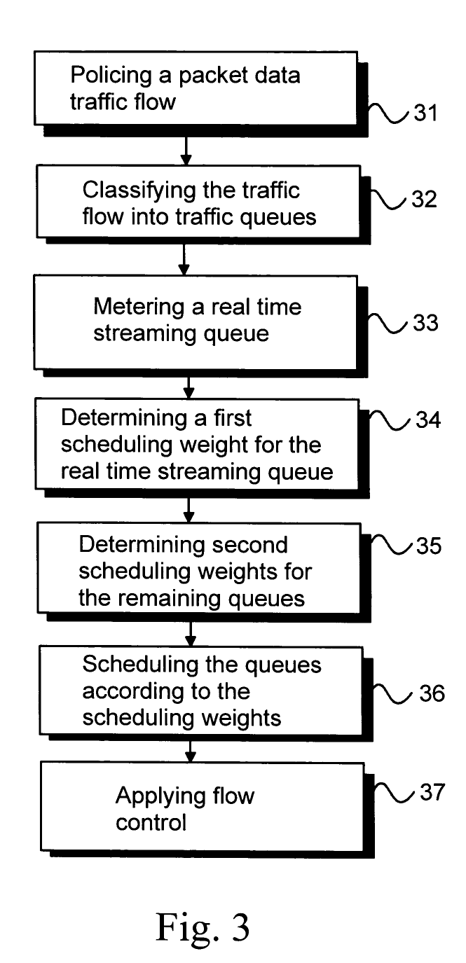

FIG. 3 illustrates a packet scheduling method for a GPRS enabled GSM network. In the embodiment of the invention disclosed in FIG. 3 a packet data traffic flow is policed before classifying in order to conform the flow to a predetermined maximum bit rate, phase 31. The traffic flow is classified into service class specific traffic queues, phase 32. The traffic flow comprises one or more data connections of predetermined service classes, and at least one of the service classes is real time streaming traffic with a predetermined guaranteed bit rate requirement. In phase 33 a real time streaming service class specific traffic queue is metered to determine whether its bit rate is below or over its guaranteed bit rate requirement. A first scheduling weight is determined for the metered real time streaming service class specific traffic queue based on whether its determined bit rate is below or over its guaranteed bit rate requirement, phase 34. Second scheduling weights for the remaining traffic queues are determined, phase 35. The traffic queues are scheduled according to the determined scheduling weights, phase 36. Finally flow control is applied to the scheduled traffic flow, phase 37.

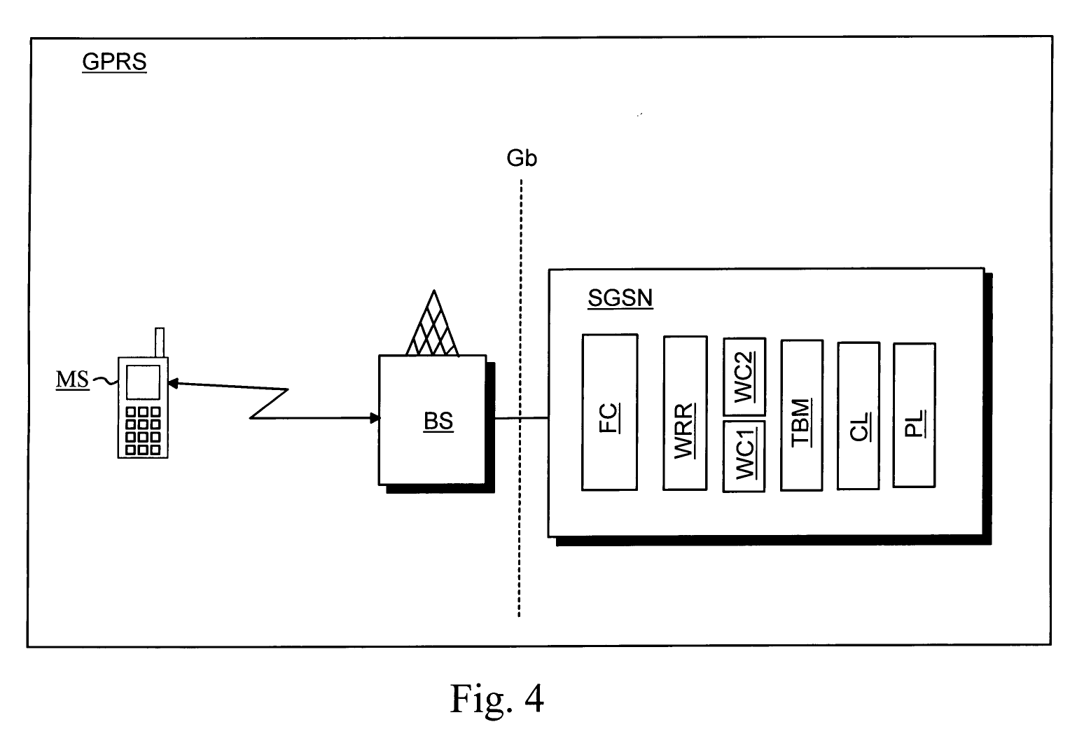

FIG. 4 illustrates a packet scheduling system for a GPRS enabled GSM network. The packet scheduling system illustrated in FIG. 4 comprises a base station BS for transmitting a packet data traffic flow comprising one or more data connections of predetermined service classes. At least one of the service classes is real time streaming traffic with a predetermined guaranteed bit rate requirement. The packet scheduling system illustrated in FIG. 4 further comprises a terminal device MS for receiving the transmitted traffic flow. The packet scheduling system illustrated in FIG. 4 further comprises a policer PL for policing the traffic flow before classifying in order to conform the flow to a predetermined maximum bit rate. The packet scheduling system illustrated in FIG. 4 further comprises a classifier CL for classifying the traffic flow to be transmitted into service class specific traffic queues.

The packet scheduling system illustrated in FIG. 4 further comprises a meter TBM for metering a real time streaming service class specific traffic queue to determine whether its bit rate is below or over its guaranteed bit rate requirement. the meter is implemented by utilizing a first token bucket-algorithm having a first bucket size B_{streaming}. The packet scheduling system illustrated in FIG. 4 further comprises a first weight calculator WC1 for determining a first scheduling weight for the metered real time streaming service class specific traffic queue based on whether its determined bit rate is below or over its guaranteed bit rate requirement.

The packet scheduling system illustrated in FIG. 4 further comprises a second weight calculator WC2 for determining second scheduling weights for the remaining traffic queues. The packet scheduling system illustrated in FIG. 4 further comprises a scheduler WRR for scheduling the traffic queues according to the determined scheduling weights. The scheduler is implemented by utilizing a Weighted Round Robin-algorithm. The packet scheduling system illustrated in FIG. 4 further comprises a flow controller FL for applying flow control to the scheduled traffic flow. The flow controller is implemented by utilizing a second token bucket-algorithm having a second bucket size Bₘₐₓ.

In the packet scheduling system illustrated in FIG. 4 the classifier, meter, first weight calculator, second weight calculator, scheduler, policer and flow controller are implemented in a Serving GPRS Support Node SGSN of the GPRS enabled GSM network. The SGSN is connected to the base station through Gb interface.

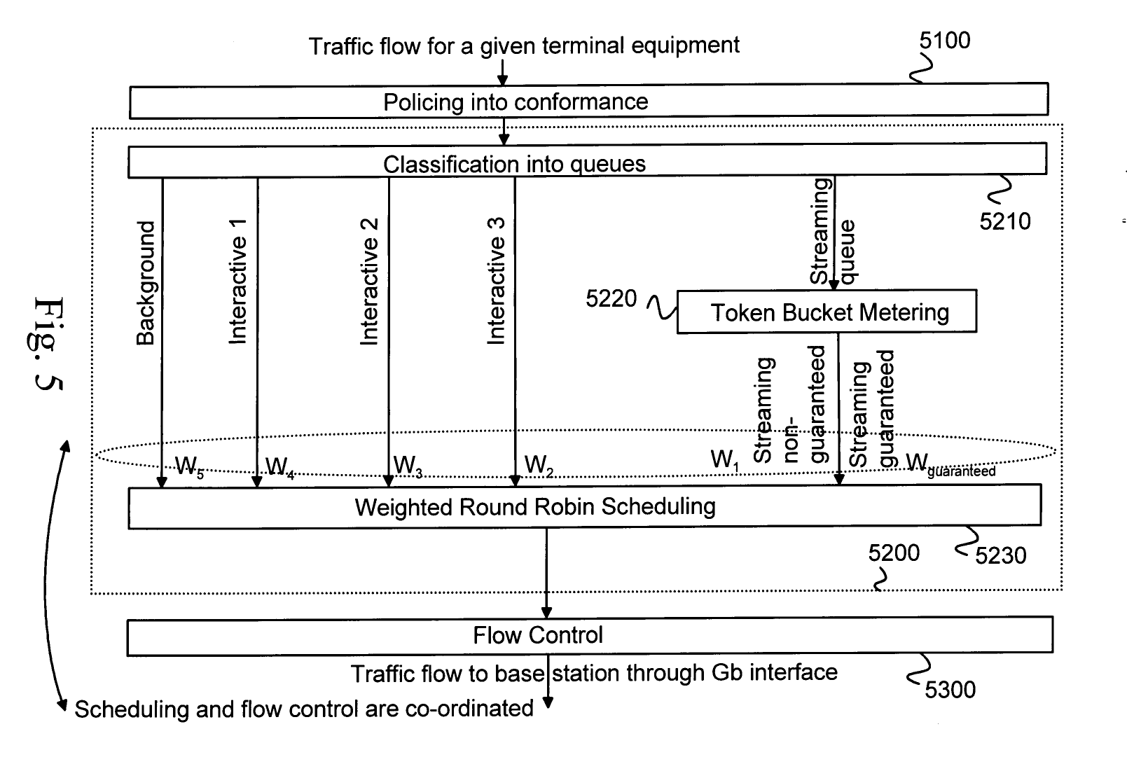

FIG. 5 further illustrates a scheduler according to one embodiment of the present invention. In the embodiment of the invention disclosed in FIG. 5 a packet data traffic flow directed to a given terminal equipment is policed before classifying in order to conform the flow to a predetermined maximum bit rate, phase 5100. Next, packet scheduling according to the present invention is executed, phase 5200. The packet scheduling comprises the following phases. The traffic flow is classified into service class specific traffic queues, phase 5210. In the embodiment of the invention disclosed in FIG. 5 the queues comprise a queue for background services, a queue for interactive services with traffic handling priority 1, a queue for interactive services with traffic handling priority 2, a queue for interactive services with traffic handling priority 3, and a queue for real time streaming services. The real time streaming services have a predetermined guaranteed bit rate requirement.

Next, the real time streaming service class specific traffic queue is metered by utilizing a first token bucket-algorithm having a first bucket size B_{streaming} to determine whether its bit rate is below or over its guaranteed bit rate requirement, phase 5220. A first scheduling weight is determined for the metered real time streaming service class specific traffic queue based on whether its determined bit rate is below or over its guaranteed bit rate requirement. In the embodiment of the invention disclosed in FIG. 5 the first scheduling weight for the metered real time streaming service class specific traffic queue is determined as W₁ if the metering indicates that the streaming queue is exceeding the guaranteed bit rate. Therefore the queue in that instant is less resource demanding, and thus the resources may be used e.g. for other queues requiring a guaranteed bit rate but currently not being provided it. The first scheduling weight for the metered real time streaming service class specific traffic queue is determined as W_{guaranteed} if the metering indicates that the streaming queue is being served a bit rate below the guaranteed bit rate. In such a case the percentage of the capacity used by this queue is preferably larger than in the previous case. Second scheduling weights W₂, W₃, W₄ and W₅ for the remaining traffic queues are determined. The traffic queues are then scheduled according to the determined first and second scheduling weights by utilizing a Weighted Round Robin-algorithm, phase 5230. Finally, after the packet scheduling is completed, flow control is applied by utilizing a second token bucket-algorithm having a second bucket size Bₘₐₓ to the scheduled traffic flow, phase 5300. In the embodiment of the invention disclosed in FIG. 5 the packet scheduling and flow control are co-ordinated with each other. This is accomplished by determining the scheduling weights suitably.

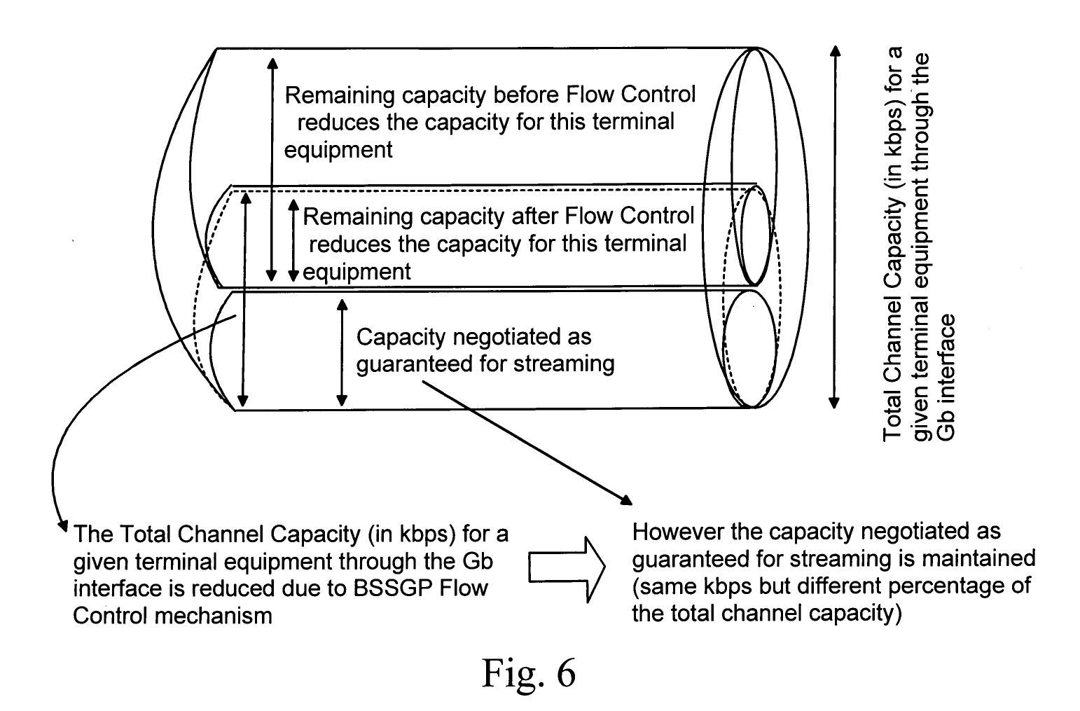

FIG. 6 further illustrates the benefits of the present invention by illustrating how a system according to the present invention performs when BSSGP Flow Control reduces the channel bit rate for a given terminal equipment. Streaming traffic by the user in question is not affected by traffic without negotiated guaranteed QoS requirements. As illustrated in FIG. 6, the capacity in kbps is maintained whereas the percentage of the total capacity represented by the guaranteed bit rate varies.

It is obvious to a person skilled in the art that with the advancement of technology, the basic idea of the invention may be implemented in various ways. The invention and its embodiments are thus not limited to the examples described above, instead they may vary within the scope of the claims.

1. A packet scheduling method for a packet data enabled radio communication network, the method comprising the step of:
classifying a packet data traffic flow into service class specific traffic queues, the traffic flow comprising one or more data connections of predetermined service classes, at least one of the service classes being real time streaming traffic with a predetermined guaranteed bit rate requirement,
characterized in that the method further comprises the steps of:
determining at least one first scheduling weight for a real time streaming service class specific traffic queue,
determining at least one second scheduling weight for at least one remaining traffic queue, and
scheduling the traffic queues according to the determined scheduling weights.

2. The method according to claim 1, characterized in that method further comprises the step of:
metering a real time streaming service class specific traffic queue to determine whether its bit rate is below or over its guaranteed bit rate requirement.

3. The method according to claim 2, characterized in that the first scheduling weight or weights for the real time streaming service class specific traffic queue is determined based on whether its determined bit rate is below or over its guaranteed bit rate requirement.

4. The method according to claim 2, characterized in that the metering is executed by utilizing a first token bucket-algorithm having a first bucket size B_{streaming}.

5. The method according to claim 1, characterized in that the scheduling is executed by utilizing a Weighted Round Robin-algorithm.

6. The method according to claim 1, characterized in that the method further comprises the step of:
policing the traffic flow before classifying in order to conform the flow to a predetermined maximum bit rate.

7. The method according to claim 1, characterized in that the method further comprises the step of:
applying flow control to the scheduled traffic flow.

8. The method according to claim 7, characterized in that the flow control is executed by utilizing a second token bucket-algorithm having a second bucket size Bₘₐₓ.

9. The method according to claim 7, characterized in that the scheduling and flow control are co-ordinated with each other.

10. The method according to claim 9, characterized in that the scheduling and flow control are co-ordinated with each other by determining the scheduling weights as:
first weight for a real time streaming service class specific traffic queue: B_{streaming}/Bₘₐₓ, and second weight for a remaining traffic queue i: wₒᵢ×(1−B_{streaming}/Bₘₐₓ).

11. The method according to claim 1, characterized in that the packet data enabled radio communication network is a GPRS enabled radio communication network.

12. The method according to claim 11, characterized in that the packet scheduling is executed in an SGSN-element of the GPRS enabled radio communication network.

13. The method according to claim 11, characterized in that the radio communication network is a GSM network.

14. A packet scheduling system for a packet data enabled radio communication network, the system comprising:
a base station (BS) for transmitting a packet data traffic flow comprising one or more data connections of predetermined service classes, at least one of the service classes being real time streaming traffic with a predetermined guaranteed bit rate requirement,
a terminal device (MS) for receiving the transmitted traffic flow, and
a classifier (CL) for classifying the traffic flow to be transmitted into service class specific traffic queues,
characterized in that the system further comprises:
a first weight calculator (WC1) for determining at least one first scheduling weight for a real time streaming service class specific traffic queue,
a second weight calculator (WC2) for determining at least one second scheduling weight for at least one remaining traffic queue, and
a scheduler (WRR) for scheduling the traffic queues according to the determined scheduling weights.

15. The packet scheduling system according to claim 14, characterized in that the system further comprises:
a meter (TBM) for metering a real time streaming service class specific traffic queue to determine whether its bit rate is below or over its guaranteed bit rate requirement.

16. The packet scheduling system according to claim 15, characterized in that the first weight calculator determines the first scheduling weight or weights for the real time streaming service class specific traffic queue based on whether its determined bit rate is below or over its guaranteed bit rate requirement.

17. The packet scheduling system according to claim 15, characterized in that the meter is implemented by utilizing a first token bucket-algorithm having a first bucket size B_{streaming}.

18. The packet scheduling system according to claim 14, characterized in that the scheduler is implemented by utilizing a Weighted Round Robin-algorithm.

19. The packet scheduling system according to claim 14, characterized in that the system further comprises:
a policer (PL) for policing the traffic flow before classifying in order to conform the flow to a predetermined maximum bit rate.

20. The packet scheduling system according to claim 14, characterized in that the system further comprises:
a flow controller (FC) for applying flow control to the scheduled traffic flow.

21. The packet scheduling system according to claim 20, characterized in that the flow controller is implemented by utilizing a second token bucket-algorithm having a second bucket size Bₘₐₓ.

22. The packet scheduling system according to claim 20, characterized in that the scheduler and flow controller are co-ordinated with each other.

23. The packet scheduling system according to claim 22, characterized in that the scheduler and flow controller are co-ordinated with each other by determining the scheduling weights as:
first weight for a real time streaming service class specific traffic queue: B_{streaming}/Bₘₐₓ, and
second weight for a remaining traffic queue i: wₒᵢ×(1−B_{streaming}/Bₘₐₓ).

24. The system according to claim 14, characterized in that the packet data enabled radio communication network is a GPRS enabled radio communication network.

25. The system according to claim 24, characterized in that the classifier, meter, first weight calculator, second weight calculator, scheduler, policer and flow controller are implemented in an SGSN-element of the GPRS enabled radio communication network.

26. The system according to claim 24, characterized in that the radio communication network is a GSM network.

27. A packet scheduling apparatus for a packet data enabled radio communication network, the apparatus comprising:
a classifier (CL) for classifying a packet data traffic flow into service class specific traffic queues, the traffic flow comprising one or more data connections of predetermined service classes, at least one of the service classes being real time streaming traffic with a predetermined guaranteed bit rate requirement,
characterized in that the apparatus further comprises:
a first weight calculator (WC1) for determining at least one first scheduling weight for a real time streaming service class specific traffic queue,
a second weight calculator (WC2) for determining at least one second scheduling weight for at least one remaining traffic queue, and
a scheduler (WRR) for scheduling the traffic queues according to the determined scheduling weights.

28. The packet scheduling apparatus according to claim 27, characterized in that the apparatus further comprises:
a meter (TBM) for metering a real time streaming service class specific traffic queue to determine whether its bit rate is below or over its guaranteed bit rate requirement.

29. The packet scheduling apparatus according to claim 28, characterized in that the first weight calculator determines the first scheduling weight or weights for the real time streaming service class specific traffic queue based on whether its determined bit rate is below or over its guaranteed bit rate requirement.

30. The packet scheduling apparatus according to claim 27, characterized in that the apparatus further comprises:
a policer (PL) for policing the traffic flow before classifying in order to conform the flow to a predetermined maximum bit rate.

31. The packet scheduling apparatus according to claim 27, characterized in that the apparatus further comprises:
a flow controller (FC) for applying flow control to the scheduled traffic flow.

32. The packet scheduling apparatus according to claim 27, characterized in that the apparatus is an SGSN-element of a GPRS enabled radio communication network.
